(19) United States
(12) Patent Application Publication
(10) Pub. No.: US 2020/0302453 A1
(43) Pub. Date: Sep. 24, 2020

(54) A SYSTEM AND METHOD FOR SIMULATING A GAME TO INDICATE A SALES TEAM PROGRESS ON A MOBILE DEVICE

(71) Applicant: MANODH MOHAN, Vazhakkala Coachin, Kerala (IN)

(72) Inventor: MANODH MOHAN, Vazhakkala Coachin, Kerala (IN)

(21) Appl. No.: 16/094,465

(22) PCT Filed: Jun. 7, 2018
(86) PCT No.: PCT/IN2018/050374

§ 371 Date: Oct. 17, 2018

(30) Foreign Application Priority Data
Jun. 13, 2017 (IN) 201741020582

(51) Int. Cl. G06Q 30/02

(52) U.S. Cl. CPC G06Q 30/0201

(57) ABSTRACT

A system and method for simulating a game to indicate a sales team progress on a mobile device is provided. The method comprises receiving inputs from the plurality of mobile devices. Updating a sales team data stored in a memory based on the received inputs. Further, comparing the updated sales team data with one or more other team's data and/or pre-determined targets for the sales team stored in the memory, and simulating a game on at least one of the plurality of mobile devices to visually represent the progress of the sales team based on the comparison. The inputs correspond to updates on sales activities performed by one or more team members of a sales team.

### FIELD OF INVENTION

The subject matter in general relates to sales management platform. More particularly, but not exclusively, the subject matter relates to simulating a game to indicate a sales team progress on a mobile device.

### BACKGROUND

Sales management systems play a key role in helping the salespeople organize their work, saving them time with efficient methods for tracking sales deals, in better managing their contacts, most importantly to be in sync with the team.

Conventionally, such systems provide an interface for sales team members to update their targets, activities, work, sales, schedules and receive leads information's. On the other hand, managers are allowed to monitor and assign tasks to their team. However, due to the minimal engaging and motivating features such systems become monotonous very soon and the sales team lose interest in updating their tasks. This results in lack of coordination within the team, and directly effects the sales.

In view of the foregoing, there is a need for an improved sales management system which keeps the team engaged and motivated all the time, and at the same time provide a simplistic view to understand progress of different teams and team members.

### SUMMARY

Accordingly, an improved technique to overcome the above problems is needed. To fulfill this need, a system and method for simulating a game to indicate a sales team progress on a mobile device is provided. In an embodiment, the method for simulating a game to indicate a sales team progress on a mobile device comprises receiving inputs from the plurality of mobile devices. Further, updating a sales team data stored in a memory based on the received inputs, wherein the memory is coupled to the one or more hardware processors. Thereafter, comparing the updated sales team data with one or more other team's data and/or pre-determined targets for the sales team stored in the memory, and simulating a game on at least one of the plurality of mobile devices to visually represent the progress of the sales team based on the comparison. The inputs correspond to updates on sales activities performed by one or more team members of a sales team.

In another embodiment, the method comprises receiving an input from at least one of the plurality of mobile devices to choose a game among a plurality of games stored in the memory.

In yet another embodiment, the game is at least one of football, badminton, hockey, cricket, volleyball, rugby, basketball, wrestling, racing, and kabaddi.

In yet another embodiment, the game indicates performance of each team member associated with the sales team on a relative scale.

In yet another embodiment, the progress of the sales team is based one or more factors compared with the one or more other teams, wherein the one or more factors comprises time revenue generated, spent by the sales team, lead response time of the sales team, marketing collateral usage, opportunity win rate, average deal size, and cost of sales to revenue ratio

In yet another embodiment, the method further comprises ranking the sales team members based on the comparison.

In yet another embodiment, the method further comprises notifying the sales team about the upcoming meetings and locations.

In yet another embodiment, a system for simulating a game to indicate a sales team progress on a mobile device is provided. The system comprises one or more hardware processors configured to receive inputs from a plurality of mobile devices, wherein the inputs correspond to updates on sales activities performed by one or more team members of a sales team. Further, update a sales team data stored in a memory based on the received inputs, wherein the memory is coupled to the one or more hardware processors. Thereafter, compare the updated sales team data with one or more other team's data and/or pre-determined targets for the sales team stored in the memory, and simulate a game on at least one of the plurality of mobile devices to visually represent the progress of the sales team based on the comparison

In yet another embodiment, a non-transitory computer readable medium is provided. The non-transitory computer readable medium comprises instructions for a processor to execute steps comprising receive inputs from a plurality of mobile devices, wherein the inputs correspond to updates on sales activities performed by one or more team members of a sales team. Further, update a sales team data stored in a memory based on the received inputs, wherein the memory is coupled to the one or more hardware processors. Thereafter, compare the updated sales team data with one or more other team's data and/or pre-determined targets for the sales team stored in the memory, and simulate a game on at least one of the plurality of mobile devices to visually represent the progress of the sales team based on the comparison.

Other objects, features, and advantages of the present invention will become apparent from the following detailed description. It should be however understood that the detailed description and specific examples, while indicating preferred embodiments of the present invention, are given by way of illustration only and various modifications may naturally be performed without deviating from the present invention.

### BRIEF DESCRIPTION OF DIAGRAMS

This disclosure is illustrated by way of example and not limitation in the accompanying figures. Elements illustrated in the figures are not necessarily drawn to scale, in which like references indicate similar elements and in which:

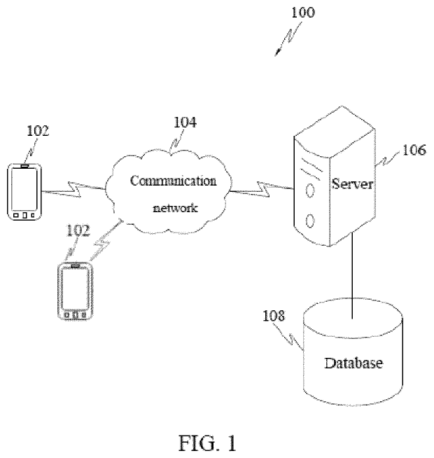

FIG. 1 is an exemplary architecture of a system 100 for simulating a game to indicate a sales team progress on a mobile device made 102, in accordance with an embodiment;

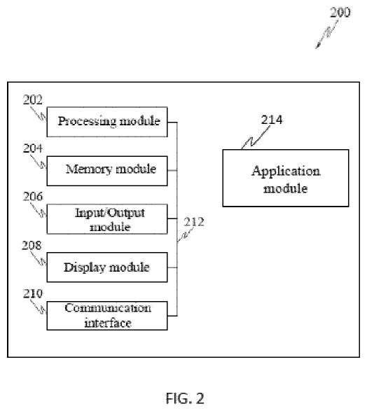

FIG. 2 is an exemplary block diagram 200 of the mobile device 102 of the system 100, in accordance with an embodiment;

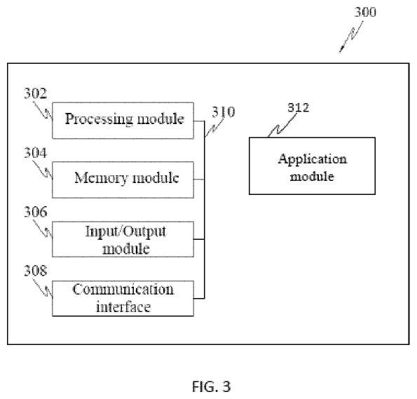

FIG. 3 is an exemplary block diagram 300 of the server 106 of the system 100, in accordance with an embodiment;

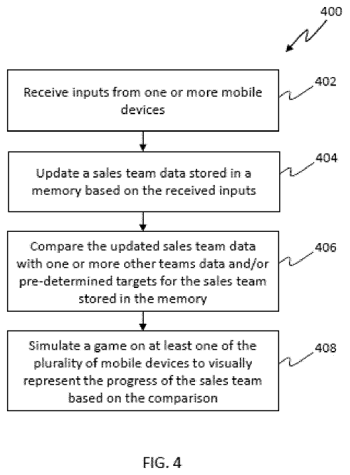

FIG. 4 is a flowchart of an exemplary method 400 for simulating a game to indicate a sales team progress on a mobile device, in accordance with an embodiment;

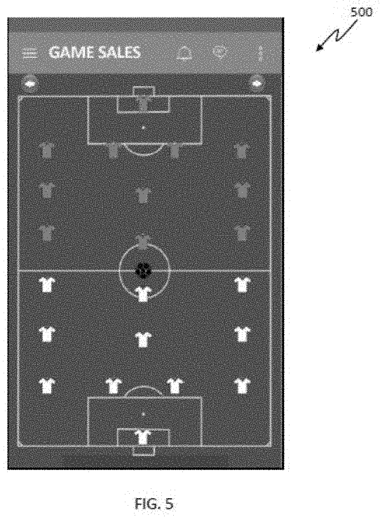

FIG. 5 illustrate an exemplary simulation of football to indicate a sales team progress of a sales team on the user interface of the mobile device 102, in accordance with an embodiment; and

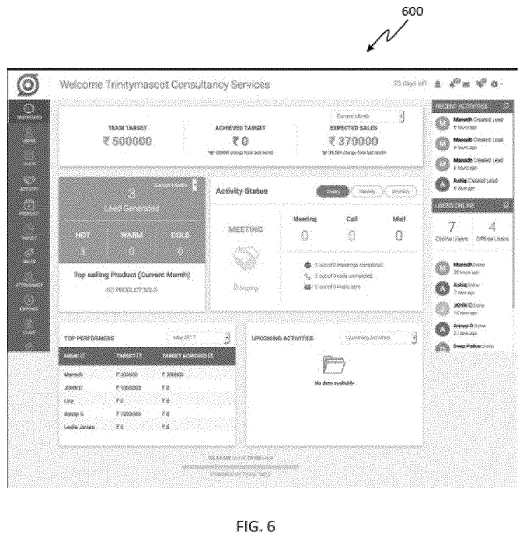

FIG. 6 illustrate an exemplary dashboard 600 on the user interface of the mobile device 102, in accordance with an embodiment.

### DETAILED DESCRIPTION OF THE INVENTION

The following detailed description includes references to the accompanying drawings, which form part of the detailed description. The drawings show illustrations in accordance with example embodiments. These example embodiments are described in enough details to enable those skilled in the art to practice the present subject matter. However, it will be apparent to one of ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a non-exclusive “or,” such that “A or B” includes “A but not B,” “B but not A,” and “A and B,” unless otherwise indicated.

It should be understood that the capabilities of the invention described in the present disclosure and elements shown in the figures may be implemented in various forms of hardware, firmware, software, non-transitory computer readable medium or combinations thereof.

### I. Overview

The embodiments disclose techniques for simulating a game to indicate a sales team progress on a mobile device. For example, embodiments provide system and method for simulating a game to indicate a sales team progress on a mobile device based on the received input and comparisons made by the server. Specifically, the system receives inputs from the plurality of mobile devices and updates a sales team data stored in a memory based on the received inputs.

Further, the system compares the updated sales team data with one or more other team's data and/or pre-determined targets for the sales team stored in the memory, and simulates a game on at least one of the plurality of mobile devices to visually represent the progress of the sales team based on the comparison.

### II System Architecture

FIG. 1 is an exemplary architecture of a system 100 for simulating a game to indicate a sales team progress on a mobile device, in accordance with an embodiment. The system 100 includes one or more mobile devices 102, a server 106 connected to a database 108 and a communication network 104 to enable communication between the device 102 and the server 106.

The mobile device 102 (also referred to as sales person device) may include mobile phones, palmtops, PDAs, tablet PCs, notebook PCs, laptops and computers, among other computing devices. In an embodiment, the mobile device 102 may include any electronic device equipped with a browser to communicate with the server 106. The mobile device 102 may be used by a sales person to input/update data corresponding to sales and others, view the team member personal progress and the entire team progress through a simulated game interface.

FIG. 2 is an exemplary block diagram 200 of the mobile device 102 of the system 100, in accordance with an embodiment. The device 102 may include a processing module 202, a memory module 204, an input/output module 206, a display module 208, a communication interface 210, an application module 214, and a bus 212 connecting all the modules of the device 102. It may also include a battery, input and output components such as a microphone, keypad, speaker and display, among others.

The processing module 202 is implemented in the form of one or more processors and may be implemented as appropriate in hardware, computer-executable instructions, firmware, or combinations thereof. Computer-executable instruction or firmware implementations of the processing module 202 may include computer-executable or machine-executable instructions written in any suitable programming language to perform the various functions described. Further, the processing module 202 may communicate with the other modules of the mobile device 102 through the bus 212.

The memory module 204 may be implemented in the form of a primary and a secondary memory. The memory module 204 may store additional data and program instructions that are loadable and executable on the processor 202, as well as data generated during the execution of these programs. Further, the memory module 204 may be volatile memory, such as random-access memory and/or a disk drive, or non-volatile memory. The memory module 204 may comprise of removable memory such as a Compact Flash card, Memory Stick, Smart Media, Multimedia Card, Secure Digital memory, or any other memory storage that exists currently or may exist in the future.

The input/output module 206 may provide an interface for input devices such as keypad, touch screen, mouse, and stylus among other input devices; and output devices such as speakers, printer, and additional displays among other.

The display module 208 may be configured to display content. The display module 208 may also be used to receive an input from a sales team member. The display module 208 may be of any display type known in the art, for example, Liquid Crystal Displays (LCD), Light emitting diode displays (LED), Cathode Ray Tube Displays (CRT), Orthogonal Liquid Crystal Displays (OLCD) or any other type of display currently existing or which may exist in the future.

The communication interface 210 may provide an interface between the communication network 104 and the device 102. The communication network interface 210 may include an antenna and a communication port, among others. The communication network interface 210 may include devices supporting both wired and wireless protocols. Data in the form of electronic, electromagnetic, optical, among other signals may be transferred via the communication network interface 210. Further, the communication network interface 210 may be present for different technologies including WLAN, USB and GPS, among others.

The application module 214 may be implemented as software. The server 106 is operable to configure and download an installer file that includes at least one application bundled with at least one configuration parameter to the plurality of devices 102 via communication network 104.

The application module 214 may be configured to interact with the processing module 202, the memory module 204, the input/output module 206, the display module 208 and the communication interface 210 in order to display the simulation of a game to indicate a sales team progress on the mobile device based on the information received from other modules of the mobile device 102.

The application module 214 may execute processes through the processing module 202 by using data stored in memory module 204. It may handle inputs and outputs by using the input/output module 206 and may display data through the display module 208.

Referring to FIG. 1 the communication network 104 may include a wired network, a wireless network, or a combination of wired network and wireless network. For example, the communication network 104 may include local area network, wide area network, and metropolitan area network, among others.

Referring to FIG. 1, the database 108 is external to the server 106. However, it is possible to implement the database 108 and the server 106 in a single system, or to have the database 108 and server 106 at a single location with wired or wireless communication there between. Further, the database 108 may be populated by receiving information from one or more external information sources. Further, multiple servers 106 and multiple databases 108 may be implemented to improve redundancy.

FIG. 3 illustrates an exemplary block diagram 300 of the server 106, in accordance with an embodiment. The server 106 may include a processing module 302, a memory module 304, an input/output module 306, a communication interface 308, an application module 312, and bus 310.

The processing module 302, memory module 304, input/output module 306, communication interface 308 and bus 310 are similar to the processing module 202, memory module 204, input/output module 206, communication interface 210 and bus 212 of the mobile device 102, respectively. Additionally, the memory module 304 may comprise of a database 108.

The application module 312 may be configured to receive inputs from one or more user devices 102, through the communication network 104. Further, may communicate with the memory module 304 to access multiple pre-stored sales targets, compare the updated records with pre-stored targets, receive a selection for a choice of game to be simulated, and deliver the simulation to the one or more mobile devices 102 indicating the progress of a sales person/sales team.

The server 106 may be implemented in the form of one or more processors with a memory coupled to the one or more processors with one or more communication interface 308. The server 106 may communicate with one or more external sources and one or more mobile devices 102 through the communication interface 308.

### III An Exemplary System for Simulating a Game to Indicate a Sales Team Progress on a Mobile Device.

In an embodiment, the server 106 may communicate with the device 102 through the application module 214 running on the mobile device 102. The server application module 312 may be configured to display a dashboard 600 on the display module 208 of the mobile device 102. The dashboard includes main menu icons such as Users, Leads, Activities, Product, Target, Sales, Attendance, Expenses, Leave, and Location, among other icons, as shown in the FIG. 6. Through the dashboard the server 200 receives inputs from a user pertaining to configuring the interface and adding key data about the sales targets, teams, leads, team member details, meetings, team member schedules, contact details, location details of the team member, and inputs to generate reports among others.

The Users icon on the dashboard 600 may configured to receive inputs pertaining to creating a new user. Further, it may also receive inputs corresponding to editing, deleting, viewing exiting users, and changing the access rights of a user, among others. The dashboard 600 may also disclose the activity list of particular user on a daily, weekly, monthly, and yearly basis. Further, the access of information to a user mobile device 102 may be controlled via the dashboard 600.

The Leads icon on the dashboard 600 may be configured to receive inputs pertaining to adding a new lead. Further, it may also receive inputs corresponding to modifying, deleting, or updating existing leads. Additionally, options for filtering the leads based on quantity, cost, and location, among other may be provided. The dashboard may also display details corresponding to a particular lead selection, where the information may include, for example, list of activities scheduled, completed activities, pending activities, and other related activities under the same lead, among others.

The Activity icon on the dashboard 600 may be configured to render information from the server about the Activity board. The Activity board may output completed, scheduled, calls, meetings, and email activities for all the leads and users. The server may provide multiple search and filtering parameters based on leads, task, user, and location, among others. Further, the server may be configured to receive inputs from a user before initiating a meeting and after finishing the meeting, thereby tracing the location information through the mobile device 102 of the user. Such information may be used by the server to calculate the overall meeting time and location, which may be displayed on dashboard under the activity board.

The Product icon on the dashboard 600 may be configured to render information from the server about the Product overview. The Product overview may include the number of product on a user's list. It may also display information corresponding to total product sales, top products, target audiences, their locations and among other data. The Product icon may also receive information corresponding to adding a new product along with the product information such as, name, description, leads, cost, and volume among other details. A user may also activate and deactivate a product via the dashboard 600.

The Target icon on the dashboard 600 may be configured to render information from the server corresponding to targets of a team, achieved target, and remaining target among others. In an embodiment, the achieved target may correspond to a target achieved by a manager. Additionally, the dashboard may also receive inputs corresponding to adding monthly targets to each team member, a user, a manager, or a team, among others.

The Sales icon on the dashboard 600 may be configured to render information from the server corresponding sales overview to depict total sales achieved. Further, filters may be provided based on the user, lead, location, or company, among. others. Options to modify, delete, approve or reject sales may be provided on the dashboard 600.

The Attendance icon on the dashboard 600 may show total staff/users accessing the dashboard. Further it may also display status of a user mobile device 102 indicating the user's attendance. The dashboard may also display the summary of a user's activities, previous history with time, date and location information.

The Expense icon on the dashboard 600 may be configured to render information from the server corresponding to expense overview. The expense overview discloses the amount requested by a user or a team for various daily operations. The expense overview may also render information corresponding to incurred expenses, and pending payments on a daily, monthly and yearly basis. A user may be allowed to add, delete, approve, disapprove or modify expenses.

The Leave Icon on the dashboard 600 may be configured to render information from the server corresponding to Leave board. The Leave board may display leave request from a team member/user, total leaves in the current month, total number of users/team members on leave in a given month, add, approve, reject, or modify options, among others. In an embodiment, a manager/team lead may be allowed to add new leaves on behalf of a user.

The location Icon on the dashboard 600 may be configured to render information from the server corresponding to location of a user based on mobile device 102. The server may also timely share information about number of online and offline users. Additionally, a team manager/lead may be able to track the route the user has travelled on the dashboard 600.

A Team icon on the dashboard 600 may be configured to render information from the server corresponding to team hierarchy. Additionally, a user may be allowed to add new users, change teams, or modify hierarchy, among other options. A battery icon on the dashboard 600 may be configured to render information on the battery level of the mobile devices corresponding to team members. Additionally, contact icon may be configured to render contact information of the lead and other team members from the server. A MIS Report Icon may be configured to render reports corresponding to lead activity, product, target, sales, attendance, expense, leave, contact and other analytical charts.

In an embodiment, the input received from one or more mobile devices 102 comprises inputs received through the dashboard 600 and any other inputs pre-shared with the server. The timely updates provided by a team member/user thorough the mobile device 102 may also correspond to inputs for the server. The inputs correspond to sales activities, leads information, scheduling, location, revenue, cost, expenses, availability, delays, products, and team updates, among others.

The information received by the server 106 is stored to the memory module 304 and/or the database 108 coupled to the server 106. When an update is received from a team member/sales person through a mobile device 102 the application module 314 verifies and validates the mobile device 102, and further analyses the received data. Thereafter the received data is used to update the data stored in the memory associated with the server 106.

The application module 314 compares the updated sales team data with one or more other team's data and/or individual pre-determined targets of the sales team. Further the server 106 may simulate a game to indicate the progress of the team with respect to their goals or to indicate a relative progress as compared to others team. The simulation may be delivered to the user device 102 and display by the application module 214 on the display module 208.

In an embodiment, the server may further provide an option on the user interface of the mobile device 102 to select a game amongst a plurality of options. In an embodiment, the different game options may include, for example, football, badminton, hockey, cricket, volleyball, rugby, basketball, wrestling, racing, and kabaddi, among others.

FIG. 5 illustrate an exemplary simulation of football to indicate a sales team progress of a sales team on the user interface of the mobile device 102, in accordance with an embodiment. The figure illustrates a basic example of the sales team. The server 106 may modify the simulation based on the updates received from the mobile devices 102 and the comparisons against the targets to indicate the progress of the team with respect to their target.

In an embodiment, the goals may be divided in to for example four phases. In an organisation where multiple teams are working towards the same goals, the server may identify that the first team have completed the first phase and simulate the game score to 1-0, further when the second team completes their first task the score may be levelled 1-1, and the game continues until one of the teams finish all four phases. The server may display multiple notifications and draw plurality of similarities based on the real-world incidents and replicate them on the simulation based on the game. For example, if one of the team members false sick on a particular day the server may simulate it as a player being injured on the mobile device 102. Additionally, if a team member receives a negative feedback from customer the server may simulate that into the game by giving a yellow card to a player.

The server through the application module 312 may send notifications to all the team members about the activates in a games perspective. Additionally, the team members may also know the real-world situation by clicking on the notifications. The Game interface may be provided on all the participating team members to keep them constantly motivated to achieve their respective goals.

In an embodiment, the application module 312 may assign each of the team members a rating based on their performance with respect to their assigned individual targets and team performance. Further, based on the rating the players may be assigned avatars of the top ranked players.

In an embodiment, the server may calculate the progress of the sales team based on one or more factors of a sales team compared with the one or more factors of the other teams, wherein the one or more factors comprises time spent by the sales team, revenue generated, lead response time of the sales team, marketing collateral usage, opportunity win rate, average deal size, and cost of sales to revenue ratio.

### IV An Exemplary Method for Simulating a Game to Indicate a Sales Team Progress on a Mobile Device.

FIG. 4 depicts a flowchart of an exemplary method 400 for simulating a game to indicate a sales team progress on a mobile device in accordance with an embodiment. The method 400 may be implemented by a server 106 to simulate a sales team progress on a mobile device. At step 402, inputs from the plurality of mobile devices may be received by the server 106. The inputs may correspond to updates on sales activities performed by one or more team members of a sales team.

Further, at step 404, the sales team data stored in the memory associated with the server may be updates with the receive updates at step 402. Further, at step 406, the updated sales team data is compared with the one or more other team's data and/or pre-determined targets for the sales team stored in the memory.

At step 408 a game is simulated by the server 106 based on the comparison to visually represent the progress of the sales team on the mobile device 102.

Additionally, the server may provide an option to choose from one or more games to choose from, in order to simulate the game to visually represent the progress of the sales team on the mobile device 102.

In the foregoing detailed description, numerous specific details, examples, and scenarios are explained in order to facilitate a thorough understanding of the present disclosure. However, the embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation. Thus, the scope of the invention should be determined by the appended claims and their legal equivalents rather than by details, examples, and scenarios provided.

It shall be noted that the processes described above are described as sequence of steps; this was done solely for the sake of illustration. Accordingly, it is understood that some steps may be added, some steps may be omitted, the order of the steps may be re-arranged, or some steps may be performed simultaneously.

Although embodiments have been described with reference to specific example embodiments, it will be evident that various combinations, modifications, additions, and omissions may be made to these embodiments without departing from the broader spirit and scope of the foregoing disclosure and appended claims. Accordingly, the specification and drawings are to be regarded in an illustrative sense rather than a restrictive sense.

It is to be understood that the phraseology or terminology employed herein is for the purpose of description and not of limitation.

What is claimed is:

1. A method for simulating a game to indicate a sales team progress on a mobile device, the method comprising:
in a server comprising one or more hardware processors configured to communicate with a plurality of mobile devices through a communication network:
receiving inputs from the plurality of mobile devices, wherein the inputs correspond to updates on sales activities performed by one or more team members of a sales team;
updating a sales team data stored in a memory based on the received inputs, wherein the memory is coupled to the one or more hardware processors;
comparing the updated sales team data with one or more other team's data and/or pre-determined targets for the sales team stored in the memory; and
simulating a game on at least one of the plurality of mobile devices to visually represent the progress of the sales team based on the comparison.

2. The method according to claim 1, further comprising receiving an input from at least one of the plurality of mobile devices to choose a game among a plurality of games stored in the memory.

3. The method according to claim 1, wherein the game is at least one of football, badminton, hockey, cricket, volleyball, rugby, basketball, wrestling, racing, and kabaddi.

4. The method according to claim 1, wherein the game indicates performance of each team member associated with the sales team on a relative scale.

5. The method according to claim 1, wherein the progress of the sales team is calculated based on the comparison of one or more factors of the sales team with the one or more other teams, wherein the one or more factors comprises time, spent by the sales team, revenue generated, lead response time of the sales team, marketing collateral usage, opportunity win rate, average deal size, and cost of sales to revenue ratio.

6. The method according to claim 1, further comprising ranking the sales team members associated with the plurality of mobile devices based on the comparison.

7. The method according to claim 1, further comprising modifying the simulation of the game based on the updates received from the plurality of mobile devices.

8. A system for simulating a game to indicate a sales team progress on a mobile device, the system comprising:
one or more hardware processors configured to:
receive inputs from a plurality of mobile devices, wherein the inputs correspond to updates on sales activities performed by one or more team members of a sales team;
update a sales team data stored in a memory based on the received inputs, wherein the memory is coupled to the one or more hardware processors;
compare the updated sales team data with one or more other team's data and/or pre-determined targets for the sales team stored in the memory; and
simulate a game on at least one of the plurality of mobile devices to visually represent the progress of the sales team based on the comparison.

9. A non-transitory computer readable medium having stored therein a set of instructions for simulating a game to indicate a sales team progress on a mobile device, wherein the set of instructions when executed by a processor causes the processor to performs steps comprising:
in a server configured to communicate with a plurality of mobile devices through a communication network:
receiving inputs from the plurality of mobile devices, wherein the inputs correspond to updates on sales activities performed by one or more team members of a sales team;
updating a sales team data stored in a memory based on the received inputs, wherein the memory is coupled to the one or more hardware processors;
comparing the updated sales team data with one or more other team's data and/or pre-determined targets for the sales team stored in the memory; and
simulating a game on at least one of the plurality of mobile devices to visually represent the progress of the sales team based on the comparison.
